(19) United States
(12) Patent Application Publication
(10) Pub. No.: US 2011/0310701 A1
(43) Pub. Date: Dec. 22, 2011

(54) Seismic Telemetry and Communications System

(76) Inventor: Gerard Schuster, Salt Lake City, UT (US)

(21) Appl. No.: 12/968,774

(22) Filed: Dec. 15, 2010

Related U.S. Application Data
(60) Provisional application No. 61/286,625, filed on Dec. 15, 2009.

(51) Int. Cl. G01V 1/28; G01V 1/40

(52) U.S. Cl. 367/38; 367/81

(57) ABSTRACT

A system for transmitting telemetry data between an underground structure and a location above the underground structure includes a network of receiving devices within the underground structure which gathers telemetry data from a data transmitter located within the underground structure. An underground broadcasting station in communication with the network of receiving devices includes an underground processing device for converting the telemetry data into an encoded impactor signal and a seismic generator in contact with the underground structure and driven by the encoded impactor signal to broadcast an encoded seismic signal through an adjacent earthen formation. The system includes a receiving station having a seismic sensor and a processing device. The seismic sensor is in contact with the earthen formation at a remote location substantially above the underground structure. The processing device is in communication with seismic sensor and can convert the received encoded seismic signal into telemetry data.

### RELATED APPLICATIONS

This application claims the benefit of Provisional Application No. 61/286,625, filed Dec. 15, 2009, which is incorporated by reference in its entirety.

### BACKGROUND AND RELATED ART

Over the past several decades, the U.S. Government, operators of underground mines, and universities have expended considerable effort in improving mine safety. Since the 1970's these activities have included the development of seismic monitoring systems to pinpoint localized seismic events in the mine, such as rockbursts. Similar efforts have been geared toward locating trapped miners in the event of an emergency. Both types of seismic monitoring systems are related, in that they can include interconnected geophones buried near the surface level. The rockburst system generally uses more permanently installed geophones, while the emergency system generally uses portable surface geophones which can be installed and configured in a few hours.

Typically, permanently installed rockburst systems apply a limited number of sensors spread out over a wide area, such as over the entire footprint of the mine, that can extend for miles in several directions. This widely-spaced, permanent array can provide coarse measurements suitable for monitoring large, noisy, low frequency seismic events, such as rockbursts, and estimating the general location of these events in the mine. Unfortunately, the signal-to-noise ratio of smaller man-made seismic events, such as a trapped miner pounding on a roof bolt with a hammer, is much lower. Due to the unique characteristics of the rock strata overlying each mine, the rapid attenuation of the high frequency noise traveling through the rock, and the long distance between sensors, accurately capturing these less-powerful man-made seismic vibrations can be difficult. Furthermore, at present, installation and maintenance of a permanent geophone network over a mine extending tens of square miles with enough sensors to accurately pinpoint a man-made seismic signal at any random location in the mine can be prohibitively expensive.

In an emergency, portable systems can provide a higher resolution detection of seismic events than the permanently installed systems by placing a greater number of geophones directly over the impacted area to improve sensitivity to human-caused events. Although these types of systems are not exact, rescuers can compare the general direction of man-made impact signals generated by trapped miners with a map of the mine to determine an approximate location. Portable systems have a number of disadvantages over permanent systems. Being portable, such systems are carried to the accident site and, depending upon the surface terrain, may take hours or days to set up and configure. This is particularly disadvantageous in situations where time is of the essence, such as when miners are trapped and have limited quantities of air, sustenance and heat. Furthermore, since there is no opportunity to calibrate the system to the specific rock strata overlying the mine, the location solutions are only approximate at best.

### BRIEF DESCRIPTION OF THE DRAWINGS

Features and advantages of the present technology will be apparent from the detailed description that follows, and when taken in conjunction with the accompanying drawings together illustrate, by way of example, features of the technology. It will be readily appreciated that these drawings merely depict representative embodiments of the present technology and are not to be considered limiting of its scope, and that the components of the technology, as generally described and illustrated in the figures herein, could be arranged and designed in a variety of different configurations. Nonetheless, the present technology will be described and explained with additional specificity and detail through the use of the accompanying drawings, in which:

FIG. 1 is a schematic view of a seismic telemetry and communications system, in accordance with one embodiment;

FIG. 2 is a schematic view of the seismic telemetry and communications system of FIG. 1 during use in an emergency to communicate with or determine the location or status of miners trapped in an underground mine;

FIG. 3a and FIG. 3b are illustrations of the generation of positive and negative polarity seismic waves with an auto-mechanical seismic generation device, respectively, as utilized by one exemplary embodiment;

FIG. 4 is a velocity model for the mineshaft embedded in a layered medium, in accordance with an embodiment. Stars indicate base station locations and geophone symbols are on top surface.

FIG. 5 is a clean Green's function, or shot gather recorded for a shot at one of the base stations in the mine, in accordance with an embodiment.

FIG. 6 is a shot including random noise for use with the clean shot of FIG. 5, in accordance with an embodiment.

FIG. 7 is a correlation graph obtained by cross-correlating the clean Green's functions for different offset values X (i.e., base station locations) along the mine shaft and trial impact times of a seismic generator, in accordance with an embodiment of the present technology. The third axis is the correlation (i.e., migration) amplitude. The location of the seismic generator and the impact time are correctly indicated by the “X” and “Time shift” values at the peak normalized amplitude.

It will be understood that the above figures are merely for illustrative purposes in furthering an understanding of the technology. Further, the figures are not drawn to scale, thus dimensions and other aspects may, and generally are, exaggerated or changed to make illustrations thereof clearer. Therefore, departure can be made from the specific dimensions and aspects shown in the figures in order to practice the present technology.

### DETAILED DESCRIPTION

Reference will now be made to the exemplary embodiments illustrated in the drawings, and specific language will be used herein to describe the same. It will nevertheless be understood that no limitation of the scope of the technology is thereby intended. Alterations and further modifications of the features illustrated herein, and additional applications of the principles of the technology as illustrated herein, which would occur to one skilled in the relevant art and having possession of this disclosure, are to be considered within the scope of this disclosure.

It is noted that, as used in this specification and the appended claims, the singular forms “a,” “an,” and “the” include plural referents unless the context clearly dictates otherwise. Thus, for example, reference to “a geophone” includes one or more of such devices, reference to “a plate” includes reference to one or more of such members, and reference to “generating” includes reference to one or more of such steps.

As used herein, the term “substantially” refers to the complete or nearly complete extent or degree of an action, characteristic, property, state, structure, item, or result. The exact allowable degree of deviation from absolute completeness may in some cases depend on the specific context. However, the nearness of completion will generally be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “array” refers to an arrangement or layout including more than one sensor. An array need not be uniformly distributed. An example array is patterned having an equidistant placement of sensors in one or more directions. Further, the pattern can include offset patterns, or can be patterned in a concentrated manner at points above the underground mine. It is noted that virtually any pattern can be used, including random patterns and non-random patterns, and all such patterns are contemplated herein.

The phrase “directly above” in relation to an underground mine and the similar use of the term “directly” refer to positions that are both directly above the mine and relatively close to the point directly above the mine such that the position is functional for telemetry and other purposes. Due to the nature of mining, finding a point precisely above a mine or a specific location within the mine can be difficult and unnecessarily wasteful of resources. Therefore, points generally above the mine which are functional for the signals discussed herein are considered “directly above”, as would be recognized by one skilled in the art. In one embodiment, however, the use of “directly above a mine” indicates precise positioning above a mine.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

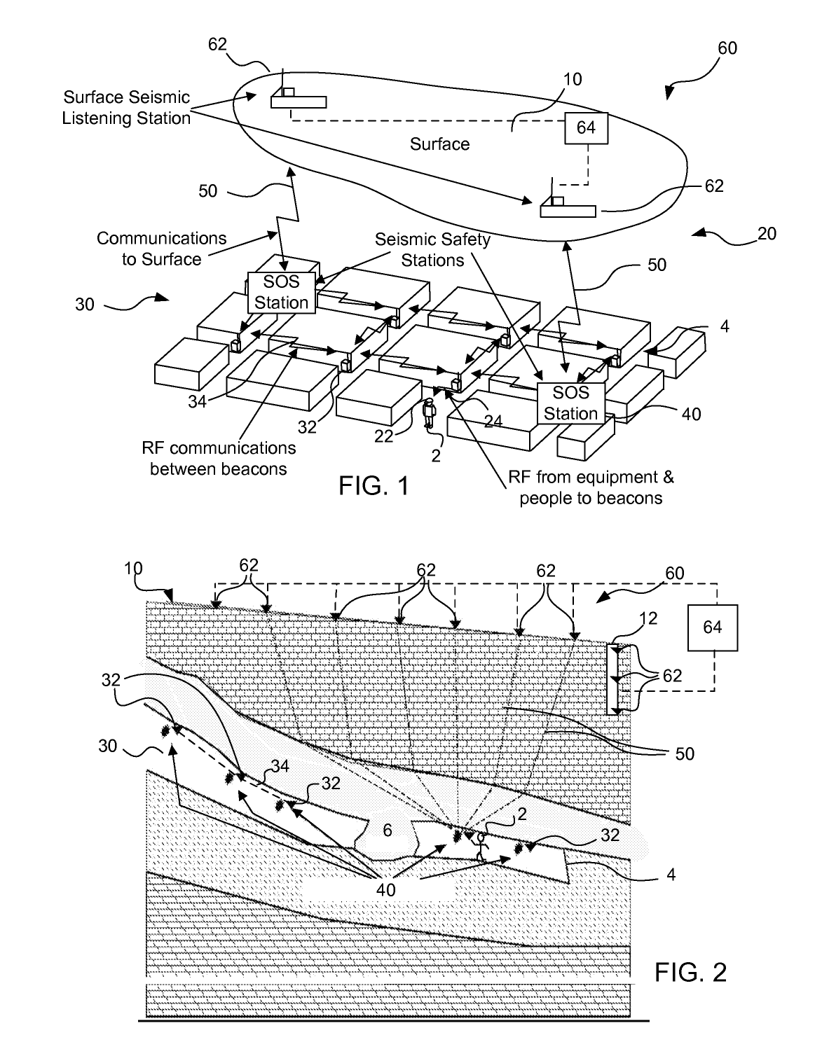

Illustrated in FIGS. 1-7 are several representative embodiments of a seismic telemetry and communications system such as may be used in an emergency, which embodiments also include one or more methods for broadcasting and receiving telemetry data between an underground structure and a remote location above the underground structure during a mining emergency, such as ceiling collapse, rockburst or accidental explosion. As described herein, the seismic telemetry and communications system provides various benefits over other devices and methods for providing emergency communication between trapped miners and parties elsewhere in the mine or on the surface. However, the recited benefits are not intended to be limiting in any way. One skilled in the art will appreciate that other benefits may also be realized upon practice of the present technology.

FIGS. 1 and 2 show an exemplary seismic telemetry and communications system 20 for transmitting telemetry data between an underground structure 4 and a remote location 60 above the underground structure during an emergency. For example, the underground structure can comprise the plurality of corridors and shafts of an underground mine, and the seismic telemetry and communications system 20 can be a backup for the normal communications systems used throughout the mine, and can be configured to operate during emergency conditions such as a roof collapse 6 or accidental explosion that results in the loss of power and trapped or injured miners.

As shown in FIG. 1, the seismic telemetry and communications system 20 can include a network 30 of receiving devices 32, such as reader devices or combination reader/beacon devices, located within the underground structure 4 which gather telemetry data 24 from one or more data transmitters 22 located within the underground structure. The data transmitters can be fixed or mobile. In mobile form, the data transmitters can include such devices as a mobile personal transponder, a mobile environmental transponder, a portable alarm relay, a portable texting or voice communications device and the like. For example, in one aspect the mobile personal transponder can be an identification tag built into the cap-lamp battery covers worn by each miner 2. The mobile personal transponder can routinely transmit a unique identification number which can be captured with the network of receiving devices or readers to track the location and movement of the miner. In another aspect, the mobile personal transponders can include personal monitoring and communications devices worn or carried by the miner 2 that sense and broadcast telemetry data, such as a miner's heart rate, a miner's breathing rate, the presence and/or concentration of a gaseous substance, or the measurement of the temperature, pressure or vibration shock experienced by the miner. In another aspect, the mobile personal transponder can be a user-directed communications device that broadcasts text messages or voice data.

In a fixed form the data transmitters 22 can include a stationary environmental transponder. The stationary environmental transponder can detect the presence and/or concentration of a gaseous substance, or measure the temperature, pressure, vibration shock or the roof loading, etc., at a particular location in the mine. The fixed data transmitter can also comprise a stationary alarm relay or a texting or voice communications device, or combinations thereof.

The telemetry data 24 broadcast from the one or more data transmitters 22 located within the underground structure or mine 4 can be received by the plurality of receiving devices 32 or nodes which can be distributed throughout the underground structure. The plurality of receiving devices can be in communication with each other over a network 30. For example, the network 30 of receiving devices 32 can include a plurality of network readers interconnected with one or more signal transmission pathways 34, such as fixed telephone wire, twisted-pair wire, Ethernet LAN cable, leaky feeder cable, cellular radio, optical fiber, wireless transmission (e.g. wide area, local area and personal area standards such as Bluetooth, IEEE 802.11 standard, IEEE 802.15 standard, IEEE 802.16 standard, ZigBee, UWB, GPRS, and the like), etc., and combinations thereof. If wireless signal transmission pathways are used, the receiving devices may be arranged sufficiently close or within line-of-sight with each other to allow uninterrupted signals. If hard-wired pathways are used, the receiving devices may be arranged around corners from each other. Many wireless signals will penetrate a limited distance through underground formations, depending on the particular materials of the underground formation. Therefore, placement can be based on the particular location materials and signal standards chosen.

The network 30 of readers 32 or combination reader/beacon devices can function as the standard day-to-day communications system located within the underground structure 4, or can be a separate system that is activated in the event of an emergency. Furthermore, the network 30 can be redundantly configured with each reader 32 being linked to multiple other readers. The network can also use multiple types of signal transmission pathways 34. Thus, the network can be maintained even if one type of signal transmission pathway is interrupted or some of the readers 32 are rendered inoperable. Moreover, each receiving device can be provided with a remote powering device, such as a battery or fuel cell, to maintain network communications in the event of a large power failure.

As shown in FIG. 1, the seismic telemetry and communications system 20 also includes one or more underground broadcasting stations 40 which are in communication with the network 30 of receiving devices 32, and which can broadcast an encoded seismic signal 50 containing telemetry data 24 to one or more seismic sensors 62 in contact with the earthen formation at a remote location substantially above the underground structure 4. As used herein, the phrases “earthen” or “earthen formation” refer to material composing part of the surface of the globe. For example, earthen can include rock, stone, dirt, sand, shale, and any other material found in the surface of the globe, including biological material. The earthen materials can be fragmented, or solid. Also included in earthen materials are any man-made materials, including but not limited to ash, steel, mill tailings, spent ores, etc. An example of an earthen formation includes rocks and dirt between an underground mine shaft and the ground surface above the mine shaft.

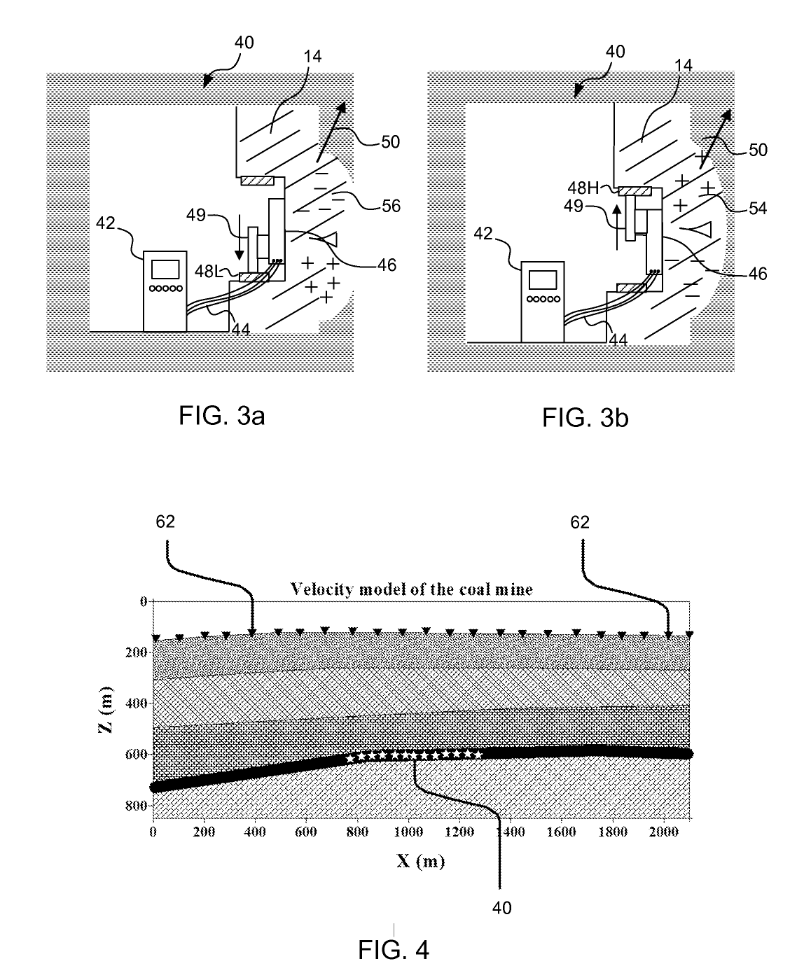

As illustrated in FIGS. 3a and 3b, the underground broadcasting stations 40 can include an underground processing device 42 connected to the network and which is configured to convert the telemetry data being carried over the network into an encoded impactor signal 44 used to drive a seismic generator 46 that has been positioned in contact with the underground structure 4. The underground processing device 42 can include any electronic device for converting the telemetry data into the encoded impactor signal, such as a programmable computer having a conversion module installed thereon, a hardwired electronic device have a pre-configured chip set with the conversion module built into the circuitry, etc.

The seismic generator 46 can be driven by the encoded impactor signal 44 to broadcast an encoded seismic signal 50 into the surrounding rock 14 of the underground structure and through the adjacent earthen formation. In one aspect the seismic generator 46 can be an auto-mechanical impactor or similar device. Moreover, the auto-mechanical impactor may be configured to generate an encoded seismic signal 50 having seismic wave components with opposing polarities 54, 56.

For instance, one embodiment of the technology includes sending an encoded seismic signal containing telemetry data through of a series of reverse or opposite polarity pulses using a form of code, such as Morse code. As shown in FIG. 3a and FIG. 3b, seismic waves traveling through the surrounding rock 14 of the earthen formation can have a polarity. The polarity can depend on the manner in which the seismic wave is initiated by the seismic generator 46. For example, the seismic generator may comprise an auto-mechanical impactor which uses an actuated hammer 49 to impact strike plates 48L, 48U in a manner to create a polarity pulse. As shown in FIG. 3a, for example, when the actuated hammer 49 strikes the lower strike plate 48L in a downward fashion, the negative polarity pulse 56 can be formed. Alternatively, a positive polarity pulse 54 can be formed by striking the upper strike plate 48U in an upward manner, as shown in FIG. 3b. Having the capability of controlling the polarity of the seismic signal increases the amount of information that can be communicated to the surface by the underground broadcasting station.

Referring back to FIGS. 1 and 2, the seismic telemetry and communications system 20 also includes a receiving station 60 which can be positioned on the surface 10 or within the adjacent earthen formation located between the underground structure 4 and the surface 10. The receiving station 60 can include one or more seismic sensors 62 in contact with the earthen formation at a remote location substantially above the underground structure, as well as a processing device 64 in communication with the one or more seismic sensors and which is configured to convert the received encoded seismic signals from each seismic sensor back into readable telemetry data.

The seismic sensors 62 can include any instrument capable of measuring seismic waves, including geophones, seismometers, and accelerographs. Moreover, the seismic sensors 62 may further comprise an array 66 of seismic sensors 62 in contact with the earthen formation above the underground structure, with the location of each individual seismic sensor being separated from an adjacent sensor by an array spacing distance 68, which distance can range from tens of meters to a kilometer or more. Spacing can be a function of performance and costs. In one embodiment, spacing can range from 0.1 km to 1 km and the geophones can use a frequency in the range of 10-20 Hz, although other geophones with higher frequencies such as 40-50 Hz geophones may also be suitable. The seismic sensors 62 can be provided with a communications link to the processing device 64. The processing device can be a central computer that has both data processing and data storage capabilities. The communications link can include physical communications cables and/or wireless technologies such as optical signals (including visible or infrared signals, for example), radio transmissions, and other wireless technologies.

In one aspect the array 66 of seismic sensors 62 may be located proximate to a surface of the earth 10 above the underground mine 4. As used herein, proximate to the surface of the earth can refer to being placed on the surface of the earth or buried a short distance below the surface of the earth. Burial below the surface of the earth can increase the signal-to-noise ratio. The burial distance below the earth can vary from 1 meter to 100 meters but may typically be in the range of from 2 to 10 meters. Proximate to the surface of the earth can further include an even greater depth below the surface of the earth while still maintaining electrical or mechanical communication with the surface of the earth, such as inside the bore of a well or coupled to a communications cable.

As shown in FIG. 2, for example, to increase the signal-to-noise ratio, a well 12 can be drilled at one or several locations and a vertical strand of sensors 62 can be located along the well (e.g. within or along walls thereof). The well can be reasonably inexpensive to drill if drilled to a shallow depth, such as less than approximately 30-50 meters in depth. Placing seismic sensors 62 or geophones along walls of a cased well can significantly increase the signal-to-noise ratio of recorded traces compared to sensors on the surface by providing a vertical profile to the received signals which can complement the horizontally placed sensors. The geophones along walls of the well will not be substantially affected by the low velocity high attenuation zone near the ground surface, which will increase the signal-to-noise ratio of these geophones compared to surface seismic sensors. In some embodiments, all of the seismic sensors 64 can be vertical component phones to optimize signal to noise ratio (or “S/N”) of the recorded signal.

The processing device 64 in communication with the one or more seismic sensors 62 can be configured to directly convert the strongest encoded seismic signal received from one or more seismic sensors into readable telemetry data. Optionally, the processing device 64 can first implement of a Time Reverse Mirror (TRM) methodology to better combine, filter and amplify the received encoded seismic signal that is received by the array 66 of seismic sensors 64 described above, prior to conversion of the encoded seismic signal into readable telemetry data. Additionally, the TRM software module can also be configured to identifying the location of the underground broadcasting station through comparison of the plurality of received encoded seismic signals with the at least one seismic reference signature

For example, to implement the Time Reverse Mirror (TRM) methodology the processing device can include a data storage module that includes at least one seismic reference signature associated with each of the one or more underground broadcasting stations. Each of the seismic reference signatures can be created by pre-recording a reference Green's function G(x,t|x′,0) for a particular underground broadcasting station, wherein x′ is a location for the broadcasting station, t is a listening time for a seismic signal started at time 0, and x is a location for at least one of the array of seismic sensors. Furthermore, the processing device can also include a Time Reverse Mirror (TRM) module that is configured to convert a plurality of received encoded seismic signals into telemetry data through comparison of the plurality of received encoded seismic signals with the at least one seismic reference signature.

During installation and calibration of the seismic telemetry and communications system 20, a reference seismic signal can be generated by the seismic generator 46 at each of the one or more underground broadcast stations 40. In one example, the reference signals from each of the underground broadcast stations can be generated sequentially, or one at a time. The reference signal or first seismic emission can be monitored by the array 66 of seismic sensors 62 and recorded as a plurality of reference seismic signals unique to that particular underground broadcasting station, depending upon the position of the broadcasting station relative to the array of sensors and the underlying rock strata (e.g. adjacent earthen formation) serving as a medium for the seismic waves. The plurality of reference seismic signals can then be communicated to the processing device 64 at the processing station 60 via each seismic sensor's communications link and processed into a unique seismic reference signature for a particular base station.

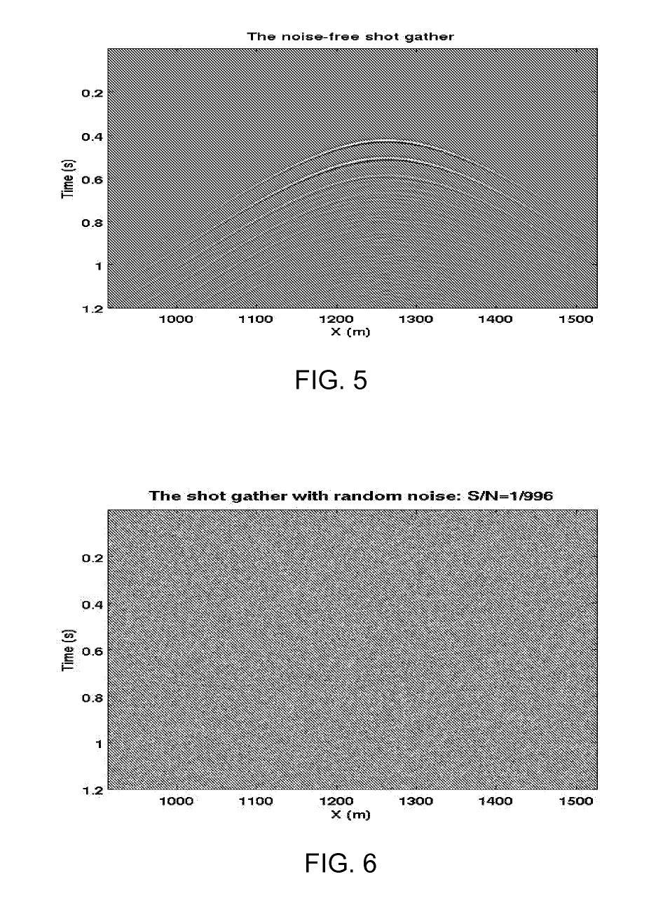

More specifically, the plurality of reference seismic signals can be processed to form the unique seismic signature, or reference seismic calibration record, for that particular underground broadcasting station 40. The reference seismic calibration record can also be known as a Green's function G(x,t|x′,0), wherein x′ is a location for the base station, t is a listening time for a seismic signal started at time 0, and x is the location for the surface seismic sensors that produced the seismic signal. A clean Green's function (i.e., high S/N ratio) similar to that shown in FIG. 5 can be recorded and archived for future use as a calibration shot gather. By combining or stacking all of the reference Green's functions traces received at an individual surface seismic sensor, a unique seismic reference signature can be recorded for a particular underground broadcasting station and any recording station on the surface. As a result, individual signals from separate stations and/or locators can later be isolated from one another.

During the installation and calibration phases of the seismic telemetry and communications system 20, this process can be replicated for each underground base station until unique seismic reference signatures have been recorded at the receiving station 60 for each underground broadcasting station 40.

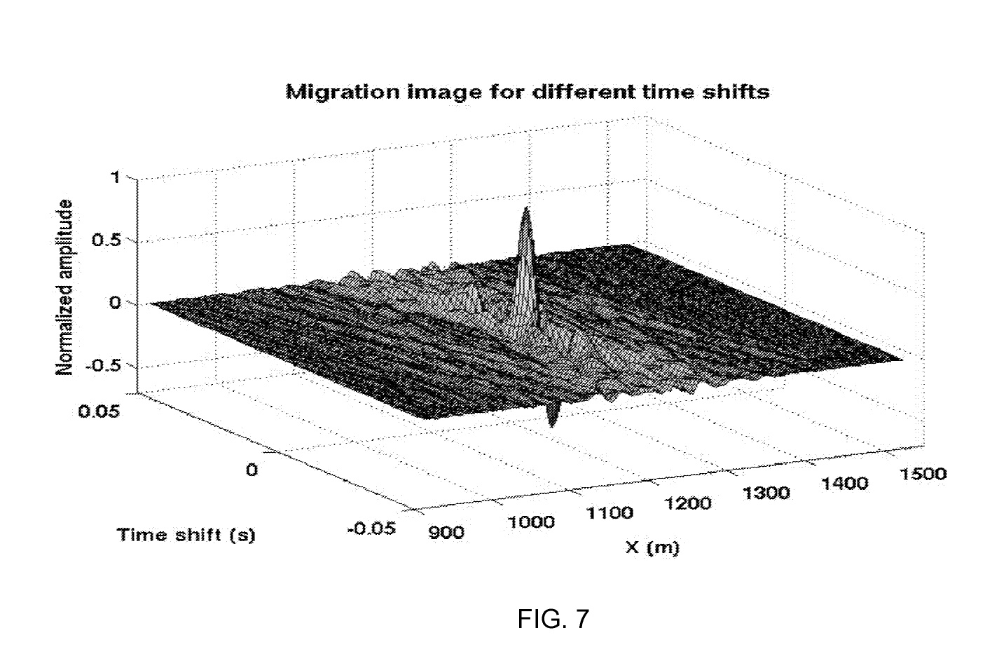

Numerical tests with computerized simulations were conducted to validate the Time Reverse Mirror aspects of the present technology. FIG. 4 depicts a computerized model with the mineshaft, broadcasting stations 40 in the mine, and surface geophones 62. A finite-difference solution to the wave equation is used to generate simulated data recorded on the surface for a point source at each of the buried base stations in the mine. An example of a resulting “clean Green's function” shot gather is shown in FIG. 5. Random noise is added to the traces to give the noisy shot gather shown in FIG. 6 for one of the underground broadcasting stations. The signal-to-noise (S/N) ratio here is 0.001 and is considered very poor. These noisy records were correlated with the “clean Green's functions” to identify the broadcasting station. FIG. 7 shows the graph of the correlated signals, which correctly indicates that the underground broadcasting station is located along the central part of the mineshaft and with the seismic generator being actuated to impact a strike plate at about the time of zero seconds.

In another aspect of the technology, the surface processing device 64 can further include a computer having a tomography module that is configured to map or image a three-dimensional velocity distribution of the adjacent earthen formation from a plurality of baseline or reference seismic signals. For instance, the first arrival travel times of the reference seismic signals can be picked from the seismic records by the tomogram module and inverted to give a 3D image or tomogram of variations in the P-wave velocity distribution. These velocity variations can be used to better understand the geology of the mine and the location of mineral deposits, resulting in improved efficiency and economics in ore extraction as well as discoveries of new deposits. In addition, the tomograms can identify geologic features, such as faults, that can be hazardous to mining operations; such identification can be used to adjust mining operations for the mitigation of mining hazards. Many 3D seismic images or tomograms can be captured over time (for example, as the calibration records can be periodically recorded or updated to ensure functionality in an emergency). As a result, temporal changes in the mine structure can be measured and used to estimate hazard potential from mine collapse.

The plurality of reference seismic signals created by a plurality of seismic generators dispersed within the underground structure can provide for more accurate and defined 3D seismic images and tomograms of the adjacent earthen formation than can otherwise be achieved using conventional seismic analysis methods.

In another embodiment of the technology, the seismic telemetry and communications system can be configured for 2-way communication between the receiving station and the telemetry data transmitter. For example, the communications system can include a receiving station having a surface broadcasting station for broadcasting a responsive encoded seismic signal through the adjacent earthen formation. The one or more underground broadcasting stations can have a seismic sensor in contact with the earthen formation and be configured to receive and convert (e.g. using a laptop computer, smart mobile phone, or other processing device) the responsive encoded seismic signal into a responsive data signal. Furthermore, the network of receiving devices can also be configured as combination reader/beacon devices which broadcast the responsive data signal throughout the underground structure. The one or more data transmitters can be configured to receive and output the responsive data signal to the trapped or injured miners. Examples of the information which could be conveyed back to the miners can include, but are not limited to: an evacuation alarm with instructions to miners having access to an exit route, acknowledgment that telemetry data has been received, notification that help is on the way, rescue or survival instructions, and so forth.

The methods and systems of certain embodiments may be implemented at least partially in hardware, software, firmware, or combinations thereof. In one embodiment, the method can be executed by software or firmware that is stored in a memory and that is executed by a suitable instruction execution system. If implemented in hardware, as in an alternative embodiment, the method can be implemented with any suitable technology that is well known in the art.

The various engines, tools, or modules discussed herein may be, for example, software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the technology. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the technology may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

Also within the scope of an embodiment is the implementation of a program or code that can be stored in a machine-readable medium to permit a computer to perform any of the methods described above.

Additionally, the signal arrows in the Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

Various functions, names, or other parameters shown in the drawings and discussed in the text have been given particular names for purposes of identification. However, the functions, names, or other parameters are only provided as some possible examples to identify the functions, variables, or other parameters. Other function names, parameter names, etc. may be used to identify the functions, or parameters shown in the drawings and discussed in the text.

The foregoing detailed description describes the technology with reference to specific representative embodiments. However, it will be appreciated that various modifications and changes can be made without departing from the scope of the present technology as set forth in the appended claims. The detailed description and accompanying drawings are to be regarded as illustrative, rather than restrictive, and any such modifications or changes are intended to fall within the scope of the present technology as described and set forth herein. More specifically, while illustrative representative embodiments of the technology have been described herein, the present technology is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, any steps recited in any method or process claims, furthermore, may be executed in any order and are not limited to the order presented in the claims. Accordingly, the scope of the technology should be determined solely by the appended claims and their legal equivalents, rather than by the descriptions and examples given above.

What is claimed is:

1. A communications system for transmitting telemetry data between an underground structure and a remote location above the underground structure, comprising:
a network of receiving devices located within an underground structure which gathers telemetry data from at least one data transmitter located within the underground structure;
at least one underground broadcasting station in communication with the network of receiving devices, comprising:
an underground processing device configured to convert the telemetry data into an encoded impactor signal; and
a seismic generator in contact with the underground structure and being driven by the encoded impactor signal to broadcast an encoded seismic signal through an adjacent earthen formation; and
a receiving station comprising:
at least one seismic sensor in contact with the earthen formation at a remote location substantially above the underground structure; and
a processing device in communication with the at least one seismic sensor and operable to convert the at least one received encoded seismic signal into telemetry data.

2. The communications system of claim 1, wherein the underground structure comprises a plurality of corridors and shafts of an underground mine.

3. The communications system of claim 1, wherein the at least one data transmitter is selected from the group consisting of a mobile personal transponder, a mobile environmental transponder, a fixed environmental transponder, an alarm relay, a texting communications device, a voice communications device, and combinations thereof.

4. The communications system of claim 3, wherein the telemetry data includes at least one of a miner's identification, a miner's location, a miner's movement, a miner's heart rate, a miner's breathing rate, a presence of a gaseous substance, a concentration of a gaseous substance, a vibration measurement, a temperature, pressure of vibration shock measurement, a roof loading measurement, and a text message.

5. The communications system of claim 3, wherein the telemetry data comprises voice data.

6. The communications system of claim 1, wherein the underground processing device comprises a programmable computer having a conversion module installed thereon for converting the telemetry data into an encoded impactor signal.

7. The communications system of claim 1, wherein the seismic generator comprises an auto-mechanical impactor which generates a seismic signal having signal components with opposite polarities.

8. The communications system of claim 1, wherein at least one seismic sensor is selected from a group consisting of geophones, seismometers, and accelerographs.

9. The communications system of claim 1, wherein the at least one seismic sensor comprises an array of seismic sensors in contact with the earthen formation above the underground structure, each seismic sensor being separated from an adjacent sensor by an array spacing distance and configured to receive the encoded seismic signal.

10. The communications system of claim 9, wherein the processing device comprises a computer including:
a storage module having at least one seismic reference signature associated with the at least one underground broadcasting station stored thereon, the seismic reference signature comprising recording a reference Green's function G(x,t|x′,0), wherein x′ is a location for the at least one underground broadcasting station, t is a listening time for a seismic signal started at time 0, and x is a location for at least one of the array of seismic sensors; and
a Time Reverse Mirror (TRM) module configured to convert a plurality of received encoded seismic signals into telemetry data through comparison of the plurality of received encoded seismic signals with at least one seismic reference signature.

11. The communications system of claim 10, wherein the Time Reverse Mirror (TRM) module is further operable to identify a location of at least one underground broadcasting station through comparison of the plurality of received encoded seismic signals with at least one seismic reference signature.

12. The communications system of claim 9, wherein the processing device further comprises a computer having a travel time tomography module configured to map a three-dimensional velocity distribution of the adjacent earthen formation from a plurality of travel times identified from received encoded seismic signals.

13. The communications system of claim 1, wherein the receiving station includes a surface broadcasting station for broadcasting a responsive encoded seismic signal through the adjacent earthen formation, and the system further comprises:
at least one underground broadcasting station having a seismic sensor in contact with the earthen formation and configured to received and convert the responsive encoded seismic signal into a responsive data signal;
the network of receiving devices being operable to broadcast the responsive data signal throughout the underground structure; and
at least one data transmitter being operable to receive and output the responsive data signal.

14. A method for broadcasting and receiving telemetry data between an underground structure and a remote location above the underground structure, comprising:
receiving telemetry data from at least one mobile data transmitter located within an underground structure;
converting the telemetry data into an encoded impactor signal;
driving a seismic signal generator in contact with the underground structure at an underground broadcasting station in accordance with the encoded impactor signal to broadcast an encoded seismic signal which travels through an adjacent earthen formation;
receiving the encoded seismic signal with at least one seismic sensor in contact with the earthen formation in a remote location substantially above the underground structure; and
converting at least one received seismic signal into telemetry data.

15. The method of claim 14, further comprising:
driving a surface seismic generator in contact with the adjacent earthen formation to generate a responsive encoded seismic signal;
receiving the responsive encoded seismic signal with a seismic sensor in contact with the earthen formation at the underground broadcasting station;
converting the responsive encoded seismic signal into a responsive data signal;
broadcasting the responsive data signal throughout the underground structure; and
receiving and outputting the responsive data signal with at least one mobile data transmitter.

16. The method of claim 14, further comprising receiving the encoded seismic signal with an array of seismic sensors in contact with the earthen formation above the underground structure, each seismic sensor being separated from an adjacent sensor by an array spacing distance.

17. The method of claim 16, further comprising:
driving the seismic generator to generate a baseline seismic signal which travels through the adjacent earthen formation;
receiving the baseline seismic signal with the array of seismic sensors in contact with the earthen formation above the underground structure; and
combining a plurality of received baseline seismic signals into at least one seismic reference signature associated with the underground broadcasting station.

18. The method of claim 17, wherein converting at least one received encoded seismic signals further comprises:
applying a Time Reverse Mirror (TRM) method to compare of the plurality of received encoded seismic signals with at least one seismic reference signature to obtain a filtered encoded seismic signal; and
converting the filtered encoded seismic signal into telemetry data.

19. The method of claim 16, further comprising processing at least one seismic reference signature into a map of the three-dimensional velocity distribution of the adjacent earthen formation.

20. A method of modeling geological structures located adjacent an underground mine, comprising:
sequentially broadcasting at least one seismic signal from each of a plurality of underground broadcasting stations located within an underground structure through an adjacent earthen formation;
receiving each of the at least one seismic signals with an array of seismic sensors in contact with the adjacent earthen formation at spaced-apart locations substantially above the underground structure; and
processing the plurality of received seismic signals to form a model of the three-dimensional velocity distribution of the adjacent earthen formation.
